(19) United States
(12) Patent Application Publication
(10) Pub. No.: US 2026/0147449 A1
(43) Pub. Date: May 28, 2026

(54) CONTENT GENERATION

(71) Applicant: Lemon Inc., Grand Cayman (KY)

(72) Inventors: Qian Huang, Culver City, CA (US); Yamilah Atallah, Culver City, CA (US)

(21) Appl. No.: 18/890,895

(22) Filed: Sep. 20, 2024

(51) Int. Cl. G06F 3/0484; G06Q 50/00; G06T 13/80

(52) U.S. Cl. CPC G06F 3/0484; G06Q 10/40; G06T 13/80

(57) ABSTRACT

Methods, systems, and apparatus, including computer programs encoded on computer storage media, for content generation. One of the methods includes receiving user selected content at a user device, the content including a first content item and a second content item; presenting the first content item in region of a user interface of an application; detecting a first user interaction occurring within a specified area of the region; determining whether the first user interaction satisfies a threshold duration; in response to determining that the first user interaction satisfies the threshold duration, presenting the second content item in the region of the user interface in place of the first content item, the second content item being associated with the first content item.

### BACKGROUND

This specification relates to generating and providing content to users.

Online social media platforms typically allow for user-generated content to be shared with other users of the platform. The user-generated content can include text, images, and video content. Some online social media platforms provide for user-generation of short lived content, for example, content that expires after a set period of time, e.g., 24 hours.

### SUMMARY

This specification describes technologies for generating and providing content to user devices. Specifically, content is generated that includes two separate content items. The two content items are linked such that a particular user interaction with a first content item results in presentation of a second content item. The user interaction can be a long press of a specific graphical user interface element presented with the first content item. The long press can be animated within the graphical element for a particular duration needed to trigger presentation of the second content item. The second content item is presented for a specified period of time, without user interaction, before reverting back to presentation of the first content item. If the user interacts with the second content item, e.g., by touching and holding the presentation of the second content item, the second content item can maintain presentation as long as the user interaction persists. In some implementations, the content can be image, audio, video, or textual content having a specified length, e.g., 15 seconds or less. The content can be short lived content, which may be referred to in this specification as a “story”, that expires a specific period of time after posting.

In general, one innovative aspect of the subject matter described in this specification can be embodied in methods that include the actions of receiving user selected content at a user device, the content including a first content item and a second content item; presenting the first content item in region of a user interface of an application; detecting a first user interaction occurring within a specified area of the region; determining whether the first user interaction satisfies a threshold duration; in response to determining that the first user interaction satisfies the threshold duration, presenting the second content item in the region of the user interface in place of the first content item, the second content item being associated with the first content item. Other embodiments of this aspect include corresponding computer systems, apparatus, and computer programs recorded on one or more computer storage devices, each configured to perform the actions of the methods.

In general, one innovative aspect of the subject matter described in this specification can be embodied in methods that include the actions of presenting a creation interface in response to a user input to an application on a user device, the user input being a request to generate a content comprising two or more content items; receiving a user input providing a first content item; receiving a user input providing a second content item; associating the first content item with the second content item to generate a dual content item, wherein the first content item is a primary content item and the second content item is a secondary content item; and providing the dual content item to a social media platform, wherein the dual content item is available for presentation to one or more user devices. Other embodiments of this aspect include corresponding computer systems, apparatus, and computer programs recorded on one or more computer storage devices, each configured to perform the actions of the methods.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. The technologies allow for more versatile content and user interaction with content. Users can create interactive content that promotes user engagement. A new control element is provided that dynamically changes in response to user interaction in a way that avoids mistouch by requiring a persistent interaction over a defined time. Additionally, the content associates two related images in a unique manner by forming content in which the related images are coupled by a user interaction, which provides user the ability to generate interesting content.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example content processing system.

FIG. 2 is a flow diagram of an example process for generating content.

FIGS. 3-9 illustrate example interfaces for generating content.

FIG. 10 is a flow diagram of an example process for presenting content.

FIGS. 11-13 illustrate example interfaces for presenting content.

FIG. 14 is a block diagram illustrating the component layers of an example animated graphical user interface element.

FIG. 15 is a flow diagram of an example process for providing an animated graphical user interface element.

FIG. 16 is a block diagram of an example computing system.

Like reference numbers and designations in the various drawings indicate like elements.

### DETAILED DESCRIPTION

The present specification describes technologies for generating and presenting content. Specifically, the present specification relates to generating and presenting content that include two or more linked content items that are selectively presented based on user interaction with a first content item. The content can be short lived and non-video content for presentation on mobile devices. For example, during creation of the content, the user can separately provide a first content item and a second content item, in order. The first content item will be a primary content item initially presented when the content is provided to other users. The second content item will replace the presentation of the first content item in response to a user interaction, for example, a long press on a displayed graphical user interface element. The second content item may only be presented for a specified duration of time before the first content item is displayed again in place of the second content item.

The displayed graphical user interface element can dynamically change to indicate a progress of the long press. For example, the graphical user interface element can appear to animate a progressive display indicating a time left remaining before the second content item is displayed. An expanding width of a layer of the graphical user interface element can be used to provide the animation effect. If the user ceases the interaction with the graphical user interface element before the animation has completed, the graphical user interface element can reset to an initial state. In response to an incomplete interaction, the duration of the long press can be decreased, e.g., a timer indicating the length of the long press deeded to present the second content item can be decreased. Future interactions can present an increased animation speed corresponding to the change in the duration of the long press.

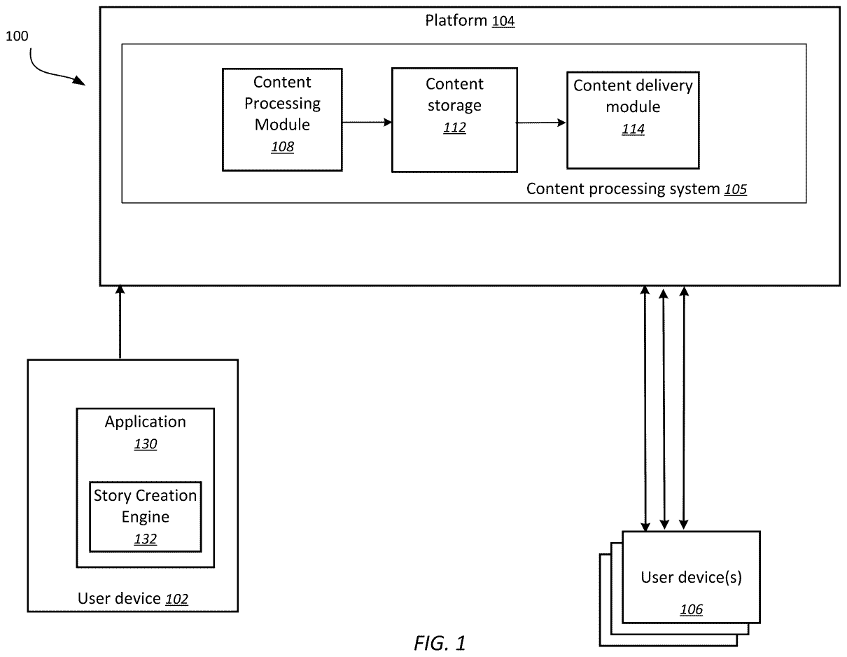

FIG. 1 is a block diagram of an example content processing system 100, e.g., illustrating a portion of an online social media or content sharing platform. The content processing system 100 illustrates an example processing of user content to generate gradient added content by a platform 104, e.g., an online social media platform, for delivery to user devices 106.

A user device 102 can provide content to the platform 104. Additionally, content can be provided by the platform 104 to user devices 106. The user devices can be any suitable Internet-connected computing device, e.g., a laptop or desktop computer, a smartphone, or an electronic tablet. The user device can be connected to the Internet through a mobile network, through an Internet service provider (ISP), or otherwise.

Each user device is configured with software, which will be referred to as a client or as client software, that in operation can access the platform 104 so that a user can interact with the platform 104. For example, the user can use the client software to upload different types of user-generated (or user obtained) content to the platform 104 as well as receive content from the platform 104. The content can be, for example, video content, audio content, textual content, or a combination of one or more of these. The client software can be a platform specific application 130 installed on the user device, and in particular a mobile device. In some alternative implementations, the user can interact with the platform using generic client applications on the user device, e.g., web browser applications.

In some implementations, the client software provides a user interface for interacting with the platform 104. The user interface can include receiving data from the platform 104 for presenting a feed of content, e.g., videos and other content, that the user can interact with. For example, the user can scroll up or down to switch between content items in the feed as well as interact with individual content items, e.g., interaction with video content can include posting comments about the video, sharing the video, or expressing approval, e.g., liking the video.

In some implementations, the content provided by the platform to user devices includes short form videos. Short form videos are videos that are typically less than 90 seconds in length. In some implementations, short form videos have lengths of between 15 and 90 seconds. By contrast, long-form videos typically have lengths of at least 3 minutes.

In some other implementations, the content provided by the platform to user devices includes short-lived content generated by users of the platform that is set to expire within a specified amount of time, e.g., 24 hours. The short-lived content can be video content, but can also be other types of content including audio content, textual content (e.g., captions, hashtags, etc.) or a combination of both.

In the example content processing system 100, the user device 102 obtains or creates short-lived content, which can be referred to as a “story.” Creation of the story can be facilitated by the application 130 using a story creation module 132. For example, the user device 102 can be a mobile device that generates the story using a camera, microphone, or text input of the mobile device. In some implementations, the story as generated on the user device may not include any video content, while in other implementations, the story can include video content. The application 130 can provide options for different types of stories. One type of story can be referred to as an AB roll story in which two content items are included in a single story, e.g., presented to receiving users as primary “A-side” content and selectively presented “B-side” content. After generating the story, the user of the user device 102 can use the client software (application 130) to upload the story to the platform 104, for example, to make the story content available for distribution to other users of the platform 104 until the specified expiry time.

The platform 104 processes content received from the user device 102. The processing can include various operations in addition to those described in this specification. For example, the content can be encoded with a particular encoding depending on the format of the received content. The content of the story can be analyzed, for example, to categorize the content or flag the content as prohibited. Different types of content can involve different processing pipelines. For example, an initial content processing module 108 can determine a type of content and direct the content along the corresponding processing pipeline. For example, short form video content may have a different processing pipeline than story content. For clarity, FIG. 1 is focused on a story processing system 105 of the platform 100 that processes and stores story content for delivery to user devices 106.

The story, after receipt from user device 102 is processed by content processing module 108. As noted above, the content processing module may determine the type of content and route the processing accordingly. For example, as story content the processing may be different from other short form video content. The story content may be separately stored, physically and/or logically, and have different presentation criteria than other video content on the platform. Other processing operations can also include labeling the story content, performing content review, e.g., for restricted content.

After processing, the story is stored in one or more storage locations 112. The storage may be a distributed storage among multiple storage devices. Further, the storage may be replicated in multiple locations such that multiple copies of the versions are stored, e.g., in multiple datacenters.

For new stories uploaded to the platform, the storage may make the story readily available for serving to user devices 106 until expiration. A content delivery module 114, in response to an interaction with different end user devices 106, can select a story to provide to particular user devices 106. The story is then provided to the user device 106 presentation. In some instances, stories are limited to distribution to other users who have a particular relationship on the platform with the creator user. A user interface provided by the application of a user device may have a separate area for stories distinct from the presentation of other platform content such as short form videos. For example, a user inbox may include avatars or other representative images corresponding to available stories.

In some implementations, story processing system 105 may include other processing, for example, compression of story data or re-encoding of input stories into a particular format.

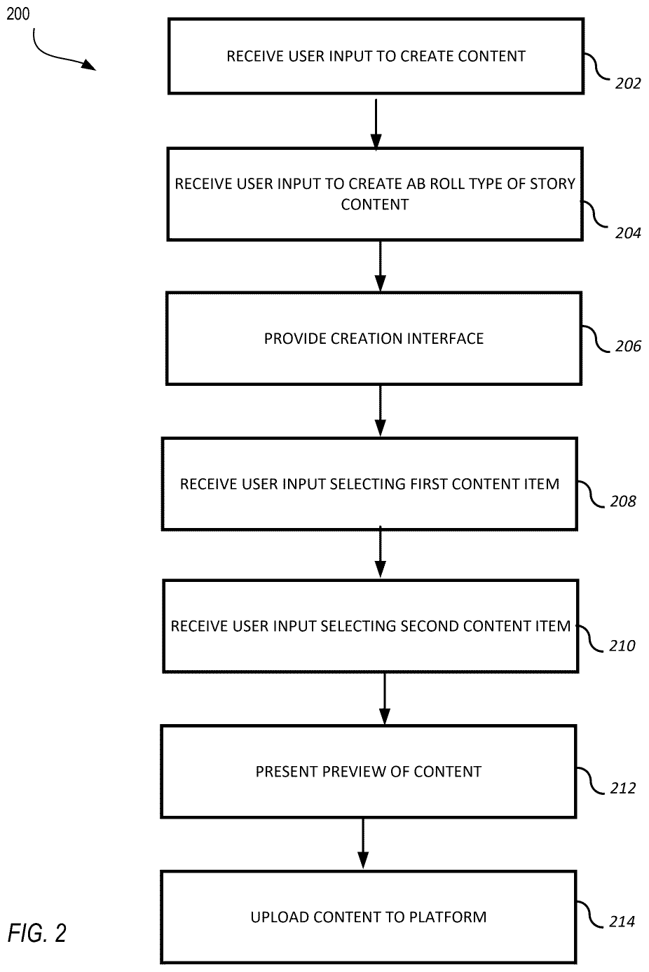

FIG. 2 is a flow diagram of an example process for generating content. For convenience, the process 200 will be described as being performed by a user device executing client software. For example, the user device 102 in FIG. 1, appropriately programmed, can perform the process 200, e.g., with use of the application 130 and story creation module 132.

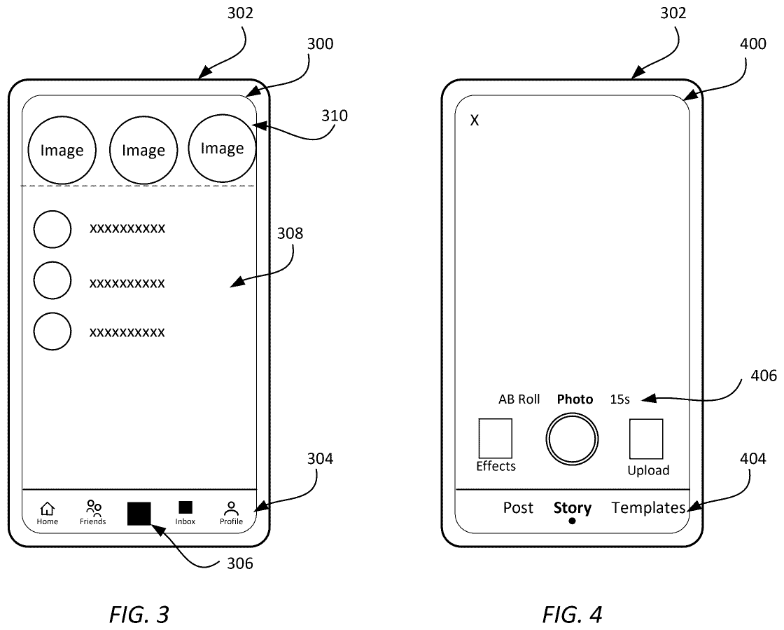

The process 200 will be further described with respect to FIGS. 3-9 illustrating example user interfaces for generating content.

The user device receives user input to create content (202). The request can be received through user interaction with a user interface of client software on the user device. For example, an application associated with a content sharing platform. The user interaction can be a user selection of a graphical control or menu option for adding content to be uploaded to the platform.

The user device receives a user input to create a particular type of content (204). The user input to create content can be associated with different types of platform content. In response to the user input at step 202, a menu can be presented with selectable content categories including, for example, a video post or a story. In response to the user selection, additional types of content can be presented. For example, in response to selecting the “story” category, a second menu can be presented that includes a photo type or an AB roll type. The AB roll type corresponds to the creation of content having more than one content item where at least one content item is only presented in response to specific user input.

In response to the user input to create a particular type of content, the user device presents a creation interface of the application (206). For example, in response to the user selection of an AB roll content type, a creation interface is presented that is tailored to the generation of the particular content type.

The user device receives a user input selecting a first content item (208). The interface can include an option to capture content directly, e.g., using a camera/microphone of the user device, or to upload content, e.g., from photos stored on the user device. The user interface can present a live view of the user device camera, e.g., a front-facing camera, and the user can capture an image from the live view, e.g., in response to a user input to an image capture element.

The user device receives a user input selecting a second content item (210). In response to the user selection of the first content item, the live view of the camera can be presented again allowing the user to capture an image or upload existing content as the second content item. The user interface can present indications distinguishing the capture of the first content item versus the second content item. For example, thumbnail representations can be presented in the creation interface indicating the current content item. Additionally, the first content item can be represented as blurred portion of an image adjacent to the live view presentation, e.g., as if the first content item has been slid to the side to capture the second content item.

The user device provides a preview of the created content (212). The user can selectively view each of the first content item and the second content item, for example, to confirm that they want to use the captured images. Additionally, the user can augment one or both content items by adding overlay text, stickers, etc. For example, the user can type text to be overlaid on top of the first content item. The user can adjust the style and position of the text. Once the user is satisfied with the content items, the user can select an upload element in the user interface.

The user device uploads the content to the platform (214). In response to the user selection of the upload element, the user device transmits the story content to the platform to be made available for delivery to other user devices. The transmitted story content includes the first content item, the second content item, and any annotations, as well as information associating the content items, e.g., indicating the ordering of content items so that the first content item is a primary content item and the second content item is a secondary content item that is only presented in response to specific user interaction within the presentation of the first content item.

While the example process 200 uses two content items, other implementation may allow for the user input selection of more than two content items, for example, to be presented in sequence in response to particular user interactions with a preceding displayed content item.

FIG. 3 shows an example user interface 300 of a mobile application. The user interface 300 is presented on a screen of a user device 302, e.g., a mobile phone. A menu portion 304 of the user interface includes various selectable menu items including a home element, a friends element, an inbox element, a profile element, and an add content element 306. In the example shown, the user interface 300 presents a home screen 308 in the main body of the user interface. The inbox may include, for example, different notifications including notifications of new followers to the user's account, activity notifications and system notifications. The inbox may also include a top portion 310 that includes one or more stories from other users of the platform. Each story may be represented by a thumbnail from the story or a profile picture of the corresponding user. The other users may be limited to those with a particular relationship with the user on the platform. The user interaction with the add content element 306, e.g., by tapping on the corresponding graphical element, can correspond to the user input to create content at 202 of process 200. The add content element 306 can be present in various different interfaces of the application.

FIG. 4 shows an example user interface 400 of the mobile application. The user interface 400 represents a content creation interface of the mobile application. The content creation interface includes content categories 404 and content types 406. In the example user interface 400, the story category is selected in the content categories 404 and the “photo” type is indicated in the content types 406. The user can change the content type by selecting a different type presented in the user interface.

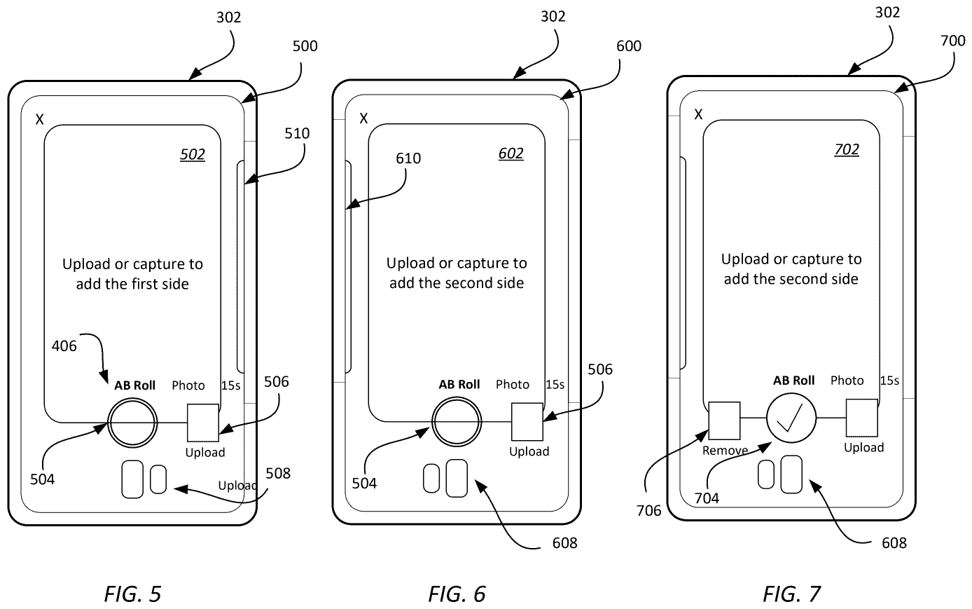

FIG. 5 shows an example user interface 500 of the mobile application. The user interface 500 represents a content creation interface in which the content type is changed to “AB roll” in the content types 406. The user interface 500 includes a capture window 502 that presents, for example, a live camera view. The user interface 500 additionally includes a capture control 504 for capturing an image from the live view and an upload control 506 for, optionally, selecting pre-existing content.

In particular, the user interface 500 illustrates the capture of a first content item for content having a first content item and a second content item. A pair of thumbnails 508 can visually indicate that the current interface relates to the first content item by the first thumbnail being presented as larger than the second thumbnail. Additionally, in some implementations, the second smaller thumbnail is blurred. Blurring the thumbnail related to the non-current content item can both indicate which content item is currently active in the creation interface as well as can reduce processing by using a lower resolution image.

The user interface 500 also includes an edge portion of the second content item window 510, visually indicating the order between the first content item and the second content item by presenting the edge of the second content item as if it represents a next image were the user to scroll the interface. The portion of the second content item window 510 can also be blurred in a similar manner as the smaller thumbnail 508.

FIG. 6 shows an example user interface 600 of the mobile application. The user interface 600 represents a content creation interface for capturing the second content item of the pair of content items. The user interface 600 includes a capture window 602 that presents, for example, a live camera view. The user interface 600 additionally includes the same capture control 504 for capturing an image from the live view and the upload control 506 for, optionally, selecting pre-existing content.

The user interface 600 illustrates the capture of the second content item for content having a first content item and a second content item. A pair of thumbnails 608 can visually indicate that the current interface relates to the second content item by the second thumbnail being presented as larger than the first thumbnail. Additionally, in some implementations, the first smaller thumbnail is blurred. The user interface 600 also includes an edge portion of the second content item window 610, visually indicating the order between the first content item and the second content item by presenting the edge of the second content item as if it represents a previous image were the user to scroll the interface. The portion of the second content item window 610 can also be blurred in a similar manner as the smaller thumbnail 608.

FIG. 7 shows an example user interface 700 of the mobile application. The user interface 700 represents a content creation interface after a user has selected the second content item. The user interface 700 includes a capture window 702 presenting the selected second content item, whether through a camera capture or a upload of a preexisting image. The user interface 700 further includes a confirm element 704, for example represented by a checkmark, and a remove element 706 for removing the second content item and selecting again. A similar interface can be presented for the first content item.

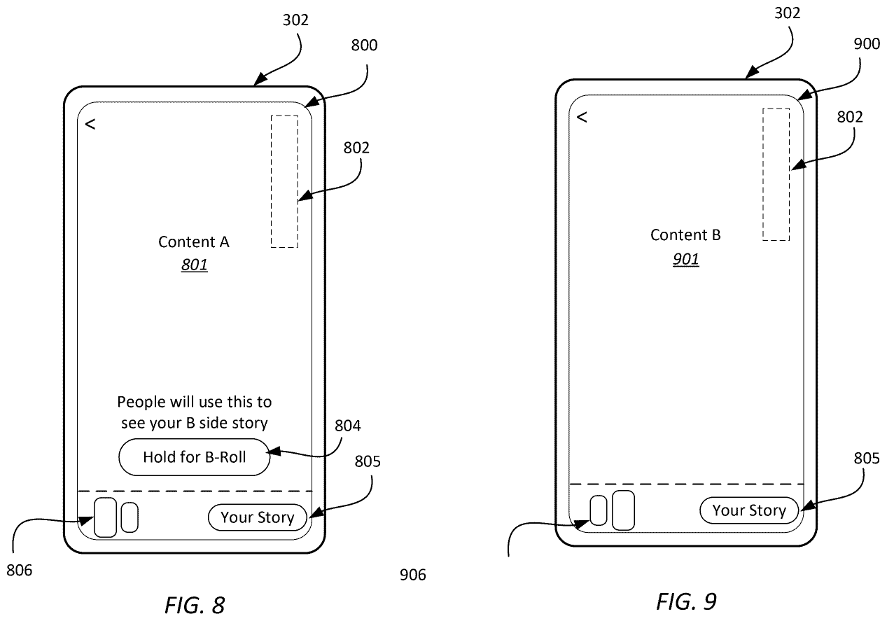

FIG. 8 shows an example user interface 800 of the mobile application. The user interface 800 represents a preview interface after a user has selected a first content item and a second content item. Specifically, the user interface 800 presents the first content item 801. A set of one or more editing tools 802 can be used by the user to add annotations to the first content item, for example, to enter overlay text and position the text relative to the first content item. The interface 800 also previews the graphical control 804 used during presentation on a receiving user's device to display the second content item. In particular, a receiving user may need to perform a long press on the graphical control 804 in order to replace the first content item with the second content item, as will be described in more detail below.

The user interface 800 also includes graphical control 805, which allows the user to upload the content to the platform. The uploaded content includes both the first and second content items, any annotations, and data indicating the relative relationship between the content items (i.e., which is to be presented first). After uploading, the content can be made available to other users of the platform.

A pair of thumbnails 806 present representations of the first content item and the second content item as well as indicating which content item is currently presented in the user interface. As illustrated in user interface 800, the first content item is presented and the first thumbnail is larger than the second thumbnail. The user can select between the first thumbnail and the second thumbnail to change the preview presentation between the first and second content items, respectively.

For example, in response to a user selection of the second thumbnail, the user interface 900 of FIG. 9 can be presented. FIG. 9 shows the example user interface 900 of the mobile application. Specifically, the user interface 900 presents the second content item 901. The set of one or more editing tools 802 can be used by the user to add annotations to the second content item, for example, to enter overlay text and position the text relative to the second content item.

A pair of thumbnails 906 present representations of the first content item and the second content item as well as indicating which is the currently presented content item in the user interface. As illustrated in user interface 900, the second content item is presented and the second thumbnail is larger than the first thumbnail.

Although FIGS. 3-9 describe a story having two content items, in some implementations the story content can include more than two content items. For example, there can be multiple layers of long presses each to reach the next content item of the story. The mechanisms described above are applicable to additional content items in the story beyond the second content item.

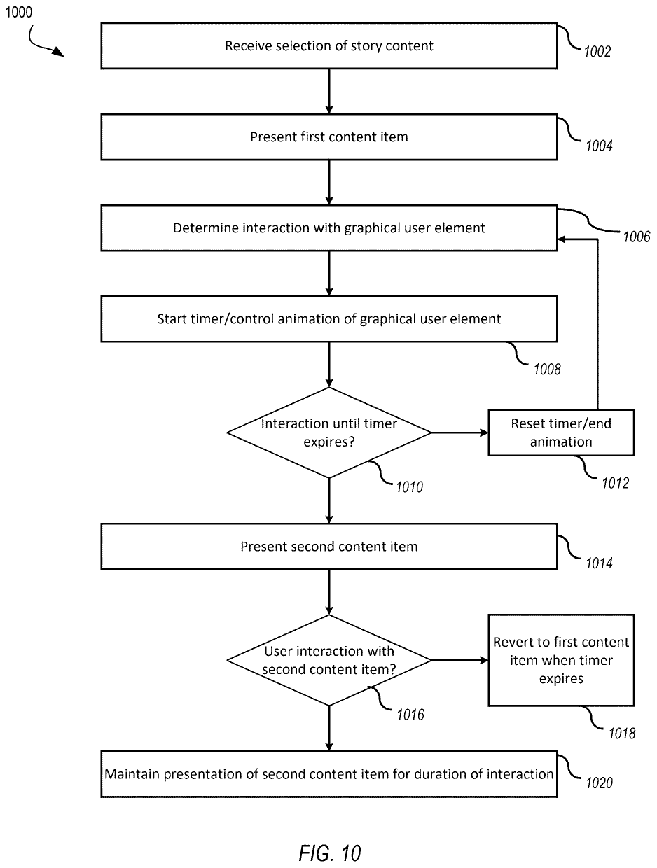

FIG. 10 is a flow diagram of an example process 1000 for presenting content. For convenience, the process 1000 will be described as being performed by a user device executing client software. For example, the user device 106 in FIG. 1, appropriately programmed, can perform the process 1000, e.g., with use of appropriate client software.

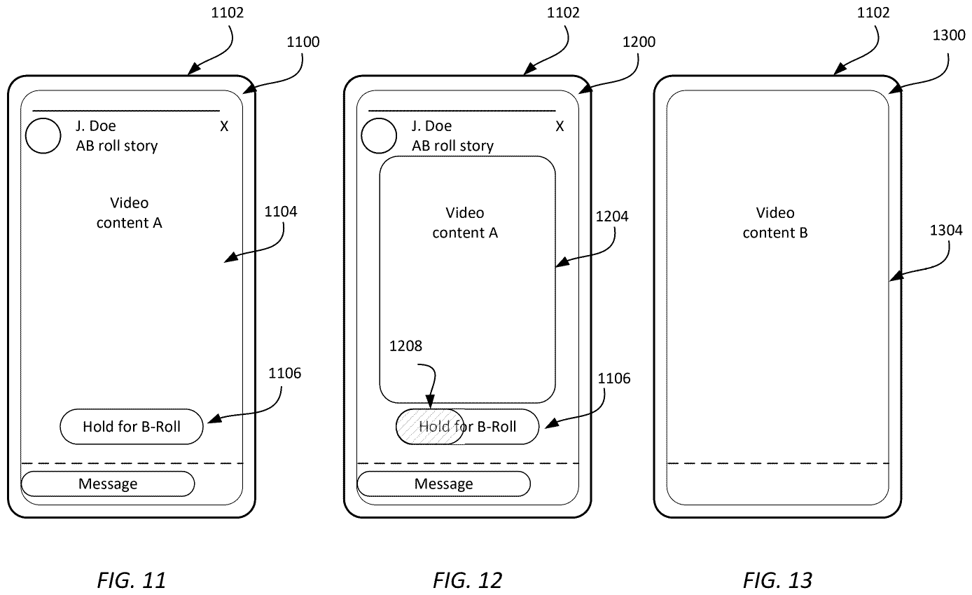

The process 1000 will be further described with respect to FIGS. 11-13 illustrating example user interfaces for presenting content.

The user device receives a selection of content (1002). For example, the user may interact with an application user interface such as that shown in FIG. 3. Representations of short-lived content, e.g., story content, can be presented in the user interface for selection (e.g., from the top portion 310 of the inbox user interface shown in FIG. 3). The user can, for example, tap on a particular story representation to select the story content.

The user device presents a first content item of the selected content (1004). As described above, the content can include more than one content item. However, upon selection only the first content item is initially presented. The first content item can be, for example, an image, text content, audio content, or video content. Additionally, the first content can include one or more annotations, e.g., an image having text annotations, stickers, or other content overlapping the image.

Along with the first content item, a graphical user interface element can be presented, for example, as an overlay of the first content item. The graphical user interface element can provide information about a possible interaction with the content. For example, the graphical user interface element can instruct the viewing user to hold the graphical user interface element to see additional content, e.g., “hold for B-roll” text on a button overlying the first content item.

The user device determines a user interaction with the graphical user interface element (1006). For example, the user device determines that a user has pressed a touch screen at a location corresponding to the graphical user interface element. In response to the user interaction, the application on the user device initiates a countdown timer and animation control (1008). The animation can provide a visual indicator of the progress toward revealing the second content item. For example, the animation can represent a “loading” or “progress” bar that progresses across the graphical user interface element. The animation and timer are linked so that the animation completes at the same time the timer expires. The graphical user interface element function and operation is described in greater detail below.

The application of the user device determines whether the user interaction continues until the timer expires (1010). The length of the timer can be, for example, three seconds. Thus, the application determines whether the user interaction, e.g., a long press, continued for three seconds. In response to determining that the user interaction stops before the expiration of the timer, the timer is reset and stopped (1012). The animation can also be reset to the initial state before user interaction. The process can then loop back to 1006 to determine whether an interaction with the graphical user interface element occurs.

In response to determining that the user interaction continued until the expiration of the timer, the second content item of the content is presented (1014). The second content item can be presented in place of the first content item within the user interface of the application. One or more transition effects can be used to transition from presentation of the first content item to presentation of the second content item. For example, a flip effect can be used to represent flipping the content from a first side corresponding to the first content item to a second side representing the second content item.

The application of the user device determines whether a new user interaction with the second content item occurs before expiration of a second timer (1016). In some implementations, the new user interaction can occur at any position within the user interface occupied by the second content item. In some other implementations, the user interaction occurs within a specified region of the user interface occupied by the second content item, e.g., lower third, lower half. The second timer can be of a suitable duration, for example, two seconds, one second, or other specified amount.

In response to determining that a new user interaction does not occur before expiration of the second timer, the application reverts to presentation of the first content item in place of the second content item (1018). Again, one or more transition effects can be used to transition from presentation of the first content item to presentation of the second content item, e.g., the image can “flip” back to the first side from the second side.

In response to determining that a new user interaction does occur before expiration of the second timer, the application maintains presentation of the second content item for the duration of the interaction (1020). For example, if the user presses the display screen of the user device at a location presenting the second content item and holds, the display of the second content item can be maintained. In some implementations, once the user releases the user interaction, the second timer can restart, either from the initial value or from the last timer value. Furthermore, in some implementations, a subsequent user interaction prior to the timer expiring can again hold the display of the second content item. In some alternative implementations, once the user releases the user interaction, the application can immediately revert to the first content item without a time.

While the example process 1000 is described with respect to two content items, other implementation may allow for the presentation of content that associates two or more content items. For example, user interaction associated with a first content item causes presentation of the second content item. A similar user interaction associated with the second content item can cause presentation of a third content item, and so on. A failed interaction at the second or subsequent content item can cause the display to revert to the first content item or to stay on the current content item.

FIGS. 11-13 illustrate example interfaces for presenting content. FIG. 11 shows an example user interface 1100 of a mobile application. The user interface 1100 is presented on a screen of a user device 1102, e.g., a mobile phone.

The user interface 1100 includes a region 1104 presenting the first content item. The first content item can be a short lived content having two content items. The first content item can be presented in response to a user selection of a story, for example, from top portion 310 shown in FIG. 3.

The user interface 110 also includes graphical user interface element 1106. The graphical user interface element 1106 is positioned within the region 1104 displaying the first content item. For example, the graphical user interface element 1106 can be an overlay over the first content item. Additionally, the graphical user interface element 1106 is an interactable element, e.g., a button or other control. The graphical user interface element 1106 also includes a prompt to the viewing user, e.g., “Hold for B-Roll” indicating an action to the viewing user.

FIG. 12 shows an example user interface 1200 of the mobile application. The user interface 1200 is presented on a screen of the user device 1102. The user interface 1200 represents the user interface in response to a user interacting with the graphical user interface element 1106 of FIG. 11. In the example interface 1200, in response to the user interaction with the graphical user interface element 1106, the first content item can be presented in a reduced form 1204 within the interface 1200. Additionally, an animated progress bar 1208 can illustrate the progress in the user interaction with the graphical user interface element 1106. For example, the shaded area representing the progress bar 1208 can increase in width across the graphical user interface element 1106 as the user interacts with the graphical user interface element 1106.

If the user releases the graphical user interface element 1106 before the progress bar 1208 has progressed to the end of the graphical user interface element 1106, the progress bar 1208 portion can disappear and the first content item can return to the previous size, e.g., as illustrated by 1104 in FIG. 11. If the user continues to hold the graphical user interface element 1106 until the progress bar 1208 reaches the end of the graphical user interface element 1106, a second content item of the content is presented.

FIG. 13 shows an example user interface 1300 of the mobile application. The user interface 1200 is presented on a screen of the user device 1102. The user interface 1300 represents the user interface in response to the user interaction with the graphical user interface element 1106 of FIGS. 11-12. The user interface 1300 includes a region 1304 presenting the second content item. The second content item of the content is illustrated as replacing the first content item shown in FIG. 11 in response to the user interaction with the graphical user interface element 1106. As discussed above with respect to FIG. 10, the second content item may only be briefly presented, after which the user interface returns to the presentation of user interface 1100 of FIG. 11. For example, a timer may decrement when the second content item is presented, after which the first content item is presented again. A user interaction with the second content item, e.g., a continued press on the user device screen at a location corresponding to the second content item, may cause the second content item to remain displayed for at least as long as the user interaction continues.

In the example shown in FIG. 13, there is no visual indication that a user interaction will cause the second content to maintain presentation. However, in some other implementations, there may be a cue to the user, for example, overlay text. In some implementations, a graphical user interface element similar to the graphical user interface element 1104 can also be used to define a particular area of the user interface to interact with in order to maintain presentation of the second content item.

Various metrics can be tracked by the platform related to the story content. For example, the number of times the second content item of the story has been presented to users can be collected and provided as content statistics to the creating user.

### Graphical User Interface Element

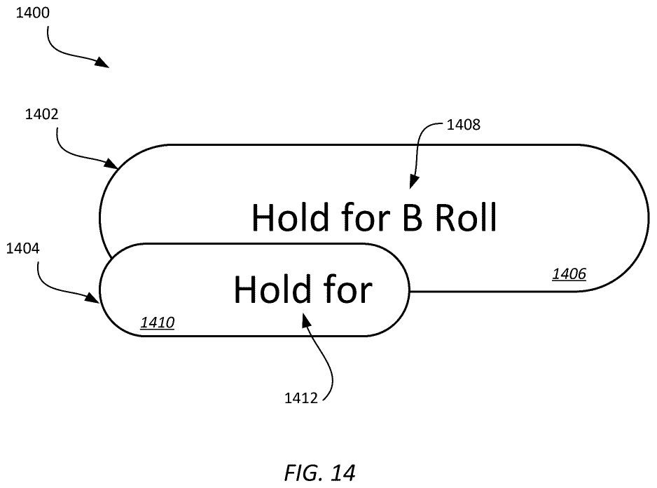

FIG. 14 is a block diagram illustrating the component layers of an example animated graphical user interface element 1400. In particular, FIG. 14 illustrates an example way of structuring a graphical user interface element which can be used, for example, in long press scenarios for executing particular functions. For example, for presenting additional content as described above.

In FIG. 14, the graphical user interface element 1400 is composed of a base layer 1402 and a top layer 1404. The base layer 1402 is formed from a base view 1406 and a base label 1408. The top layer 1404 is formed from a top view 1410 and a top label 1412. Although illustrated as staggered and of different heights, the top layer 1404 overlaps the base layer 1402 and has the same height as the base layer 1402. However, as will be described in more detail below, the top layer 1404 has a width that changes.

The base view 1406 defines the geometry of the base layer 1402, for example, as a rounded rectangle shape representing a graphical user interface control, e.g., a button. The base view 1406 can have a defined background color, e.g., white or gray. In some implementations, the base view 1406 can also be transparent or semi-transparent allowing any underlying graphics to be visible or partially visible. For example, the graphical element 1400 can be positioned on another graphical content item, e.g., an image or video.

The base label 1408 can provide a text label for the base view 1406. The text can have a specified font, color, and/or style. In some implementations, the color of the text can be black with the white background color of the base view 1406, while in other implementations different colors and backgrounds can be used.

The top view 1410 defines the geometry of the top layer 1404, for example, as a rounded rectangle shape representing a graphical user interface element, e.g., a button. The top view 1410 can have a defined background color, e.g., red. In some implementations, the background color of the top view 1410 can be a particular pattern fill or solid fill. The top label 1412 can provide a text label for the top view 1410. The text can have a specified font, color, and/or style. In some implementations, the color of the text can be white with the red background color of the top view 1410, while in other implementations different colors and backgrounds can be used.

The hierarchy of the graphical user interface element can be:
Graphical user interface element
   base view
      base label
   top view
      top Label

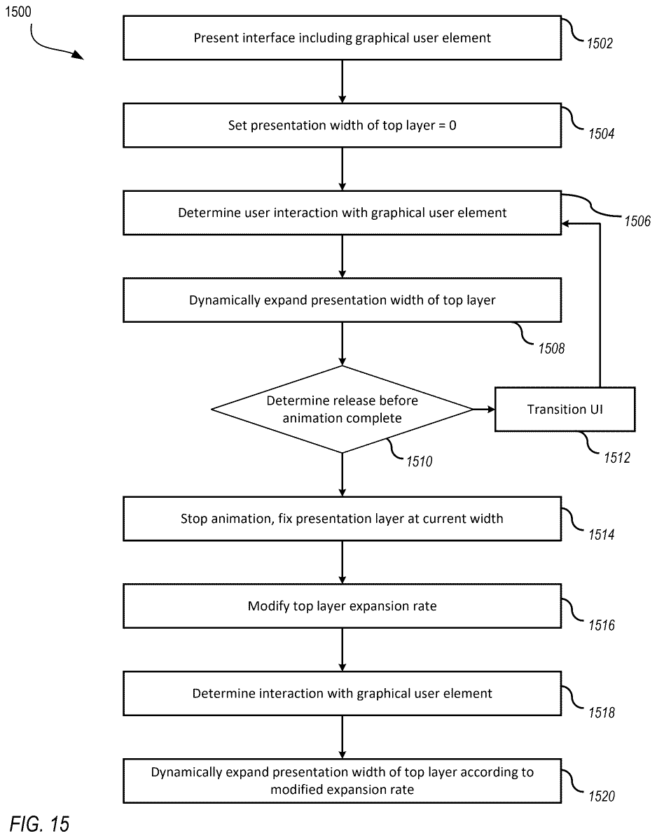

FIG. 15 is a flow diagram of an example process for providing an animated graphical user interface element. For convenience, the process 1000 will be described as being performed by a user device executing client software. For example, the user device 106 in FIG. 1, appropriately programmed, can perform the process 1000, e.g., with use of appropriate client software.

The application of the user device presents a user interface including a graphical user interface element (1502). The user interface can be presented for display, for example, within the application in response to a user input. For example, the user input can be the user's selection of particular content to present. In some implementation, the application is associated with a content sharing or social media application platform. The selected content can be the selection of a short lived content, e.g., “story” content.

The application of the user device sets a presentation width of the top layer to zero (1504). That is, when the presentation width is set to zero, only the base layer is visible in the displayed user interface. As a result, the presented user interface including the graphical user interface element presents a view of the graphical user interface element in which only the base layer can be seen by users of the device. In some implementations, the user interface presents a first content item of short lived content having two content items and the graphical user interface element is presented as an overlay to a portion of the first content item.

The application of the user device determines a user interaction with the graphical user interface element (1506). The user interaction can be, for example, a touch input to the portion of the device screen corresponding to the graphical user interface element.

In response to the determined user interaction, the application of the user device dynamically expands the presentation width of the top layer (1508). As the width of the top layer expands, it overlaps the bottom layer to generate an animation effect as the content of the top layer covers the bottom layer. For example, the animation can present as a progress bar as the top layer width increases from left to right over the bottom layer. In some implementations, the top layer text is the same as the bottom layer, but in a different color. The effect of which is the appearance of the text changing color as the width of the top layer increases. Similarly the background color can be different between the top layer and the bottom layer, so that the progressively increasing width of the top layer appears as if it is filling the graphical user interface element.

The rate of the width increase of the top layer depends on a timer set for the graphical user interface element. In particular, the user action may need to persist for a duration of the timer in order to execute the function associated with the graphical user interface element. For example, a user press of the graphical user interface element for the duration of the timer can cause a transition from the first content item to a second content item being presented in the user interface. In some implementations, the timer can be three seconds. Consequently, the width of the top layer can increase by a constant rate such that the width increases from 0 to 100% in a corresponding amount of time, e.g., three seconds. Other suitable timer values can be used.

The application of the user device determines whether the user interaction with the graphical user interface element releases prior to the timer expiring, and correspondingly before the animation has completed (1510). The determination can be based on, for example, an indication that the user is no longer touching the display of the user device at a location corresponding to the graphical user interface element.

In response to determining that the user interaction with the graphical user interface element continued until the timer expired, the application can transition the user interface according to the function associated with the graphical user interface element, e.g., to present a second content item (1512).

In response to a determination that the user interaction with the graphical user interface element released prior to the timer expiring, the application stops the animation (1514). Additionally, the application can determine the current width of the presentation layer and set it forcefully as the width of the presentation layer. Thus, the animation ceases when the user interaction stops. For example, if the timer duration is three seconds and the user interaction stops after 1 second, the current width of the presentation layer is ⅓ the width of the underlying base layer. The animation process is cancelled so that the width will not continue to increase.

The application of the user device modifies the top layer width expansion rate (1516). For example, based on the prior release of the user interface element prior to the timer expiring, the timer duration can be shortened. For example, instead of three seconds, the duration of the time can be changed to one seconds for a subsequent user interaction with the graphical user interface element in the same user session (e.g., during the same presentation of the first content item). Based on the reduced timer duration, the rate at which the presentation width of the top layer increases can be correspondingly modified such that the width expands from the fixed width of the base layer to the full width of the base layer in the new duration. Referring back to the example where the user interaction previously ended with the current width at ⅓ of the base layer, the reduced time is set to provide a faster change in the width from the forceable held presentation width of ⅓ the width of the base layer to 1/1 of the base layer in the time of the modified timer, e.g., 1 second.

In some alternative implementations, the presentation width is reset to zero or to some predefined width for the second and subsequent incomplete user interactions with the graphical user interface element. In such cases, the rate of change in the presentation width is still modified to increase the rate with respect to the initial rate.

The application of the user device determines a user interaction with the graphical user interface element (1518). For example, the user again presses the screen at a location corresponding to the graphical user interface element. In some implementations, for the user interaction to occur within a same session, the subsequent interaction occurs without navigation from the first content item being presented.

In response to the determined user interaction, the application dynamically expands the presentation width of the top layer according to the modified expansion speed (1520). If the user maintains the user interaction until the timer expires (and the animation completes), the application can transition the user interface according to the function associated with the graphical user interface element, e.g., to present a second content item.

If the user again releases the graphical user interface element prior to the timer expiring, the animation is again stopped. In some implementations, the timer is not further modified and the presentation width stays fixed at the position the previous user interaction stopped. Thus, a third or subsequent user interaction results in the same timer and presentation width expansion rate. In some other implementations, the application can determine the current width of the presentation layer each time the user interaction stops and set that current width forcefully as the width of the presentation layer. The timer can similarly be reduced by a specified amount in response to each unsuccessful attempt to maintain the user interaction until the timer expires.

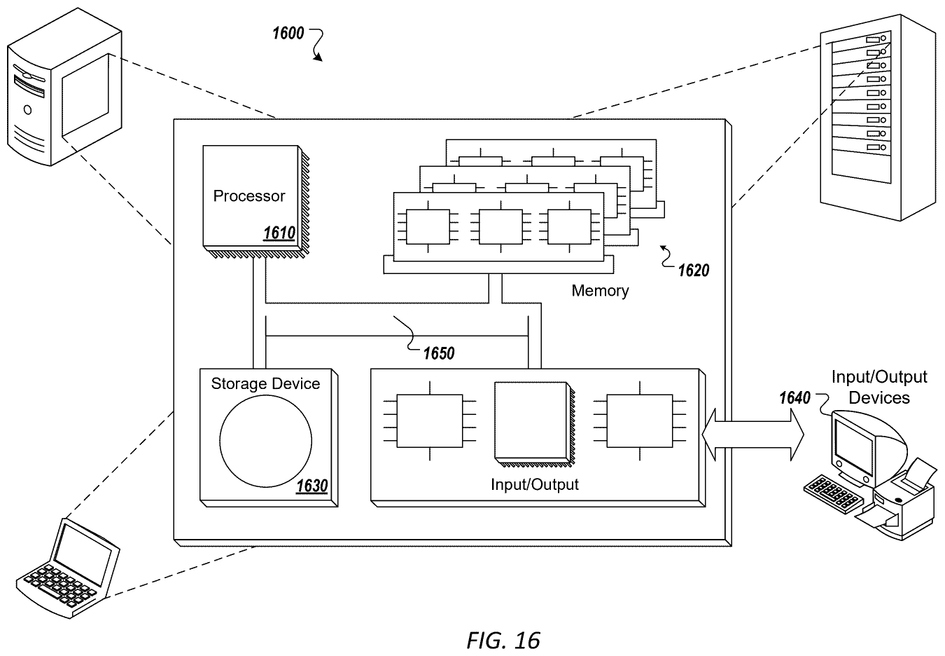

FIG. 16 is a block diagram of a schematic diagram of an example computing system 1600. The system 1600 can be used for the operations described in association with the implementations described herein. For example, the system 1600 may be included in any or all of the components of the content delivery system or video processing systems discussed in this specification. The system 1600 includes a processor 1610, a memory 1620, a storage device 1630, and an input/output device 1640. The components 1610, 1620, 1630, and 1640 are interconnected using a system bus 1650. The processor 1610 is capable of processing instructions for execution within the system 1600. In some implementations, the processor 1610 is a single-threaded processor. The processor 1610 is a multi-threaded processor. The processor 1610 is capable of processing instructions stored in the memory 1620 or on the storage device 1630 to display graphical information for a user interface on the input/output device 1640.

The memory 1620 stores information within the system 1600. In some implementations, the memory 1620 is a computer-readable medium. The memory 1620 can be a volatile memory unit or a non-volatile memory unit. The storage device 1630 is capable of providing mass storage for the system 1600. The storage device 1630 is a computer-readable medium. The storage device 1630 may be a floppy disk device, a hard disk device, an optical disk device, or a tape device. The input/output device 1640 provides input/output operations for the system 1600. The input/output device 1640 includes a keyboard and/or pointing device. The input/output device 1640 includes a display unit for displaying graphical user interfaces.

In this specification, the term “database” will be used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” will be used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following embodiments are also innovative:

Embodiment 1 is a method, the method comprising receiving user selected content at a user device, the content including a first content item and a second content item;
presenting the first content item in region of a user interface of an application; detecting a first user interaction occurring within a specified area of the region; determining whether the first user interaction satisfies a threshold duration; in response to determining that the first user interaction satisfies the threshold duration, presenting the second content item in the region of the user interface in place of the first content item, the second content item being associated with the first content item.

Embodiment 2 is the method of embodiment 1, further comprising determining whether a second user interaction occurs in the region within a specified time; and in response to determining that the second user interaction has not occurred within the specified time, presenting the first content item in the region in place of the second content item.

Embodiment 3 is the method of any one of embodiments 1 through 2, wherein in the specified area of the region comprises a graphical user interface element displayed over the first content item.

Embodiment 4 is the method of any one of embodiments 1 through 3, further comprising: in response to detecting the first user interaction: initiating a first timer, and generating an animation associated with the graphical user interface element.

Embodiment 5 is the method of any one of embodiments 1 through 4, further comprising; in response to determining that the first user interaction is discontinued before a value of the timer equals the threshold duration, discontinuing the animation associated with the graphical user interface element and discontinuing the timer.

Embodiment 6 is the method of any one of embodiments 1 through 5, wherein presenting the second content item comprises starting a second timer.

Embodiment 7 is the method of any one of embodiments 1 through 6, wherein in response to determining that the second user interaction occurs within the region within the specified time, continuing presentation of the second content item for the duration of the second user interaction.

Embodiment 8 is the method of any one of embodiments 1 through 7, wherein in response to determining that the second user interaction has ended, presenting the first content item in the region in place of the second content item.

Embodiment 9 is the method of any one of embodiments 1 through 8, wherein the presenting the second content item comprises performing a transition effect from the first content item to the second content item in the user interface.

Embodiment 10 is the method of any one of embodiments 1 through 9, wherein the receiving user selected content comprises: presenting an application interface that comprises a first region having representations of one or more content items, each content item comprising short lived content; and receiving a user selection of a representation in the first region corresponding to the content.

Embodiment 11 is a system comprising: one or more computers and one or more storage devices storing instructions that are operable, when executed by the one or more computers, to cause the one or more computers to perform the method of any one of embodiments 1 to 10.

Embodiment 12 is a computer storage medium encoded with a computer program, the program comprising instructions that are operable, when executed by data processing apparatus, to cause the data processing apparatus to perform the method of any one of embodiments 1 to 10.

Embodiment 13 is a method, the method comprising: presenting a creation interface in response to a user input to an application on a user device, the user input being a request to generate a content comprising two or more content items; receiving a user input providing a first content item; receiving a user input providing a second content item; associating the first content item with the second content item to generate a dual content item, wherein the first content item is a primary content item and the second content item is a secondary content item; and providing the dual content item to a social media platform, wherein the dual content item is available for presentation to one or more user devices.

Embodiment 14 is the method of embodiment 13, wherein receiving the user input providing the first content item comprises activating a camera feature of the user device and receiving a user capture of the first content item using the camera.

Embodiment 15 is the method of any one of embodiments 13 through 14, wherein receiving the user input providing the first content item further comprises receiving a user specification of one or more annotations to the first content item

Embodiment 16 is the method of any one of embodiments 13 through 15, further comprising: providing a preview of the created content including the first content item and the second content item, wherein each content item is represented by a thumbnail version presented in the interface, and wherein the thumbnail version of the content item of the first content item and the second content item not currently being previewed is presented in a reduced size and with a degraded representation of the content item.

Embodiment 17 is a system comprising: one or more computers and one or more storage devices storing instructions that are operable, when executed by the one or more computers, to cause the one or more computers to perform the method of any one of embodiments 13 to 16.

Embodiment 18 is a computer storage medium encoded with a computer program, the program comprising instructions that are operable, when executed by data processing apparatus, to cause the data processing apparatus to perform the method of any one of embodiments 13 to 16.

While this specification contains many specific implementation details, these should not be construed as limitations on the scope of any invention or on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
receiving user selected content at a user device, the content including a first content item and a second content item;
presenting the first content item in region of a user interface of an application;
detecting a first user interaction occurring within a specified area of the region;
determining whether the first user interaction satisfies a threshold duration;
in response to determining that the first user interaction satisfies the threshold duration, presenting the second content item in the region of the user interface in place of the first content item, the second content item being associated with the first content item.

2. The method of claim 1, further comprising:
determining whether a second user interaction occurs in the region within a specified time; and
in response to determining that the second user interaction has not occurred within the specified time, presenting the first content item in the region in place of the second content item.

3. The method of claim 1, wherein in the specified area of the region comprises a graphical user interface element displayed over the first content item.

4. The method of claim 3, further comprising:
in response to detecting the first user interaction:
initiating a first timer, and
generating an animation associated with the graphical user interface element.

5. The method of claim 4, further comprising;
in response to determining that the first user interaction is discontinued before a value of the timer equals the threshold duration, discontinuing the animation associated with the graphical user interface element and discontinuing the timer.

6. The method of claim 1, wherein presenting the second content item comprises starting a second timer.

7. The method of claim 5, wherein in response to determining that the second user interaction occurs within the region within the specified time, continuing presentation of the second content item for the duration of the second user interaction.

8. The method of claim 7, wherein in response to determining that the second user interaction has ended, presenting the first content item in the region in place of the second content item.

9. The method of claim 1, wherein the presenting the second content item comprises performing a transition effect from the first content item to the second content item in the user interface.

10. The method of claim 1, wherein the receiving user selected content comprises:
presenting an application interface that comprises a first region having representations of one or more content items, each content item comprising short lived content; and
receiving a user selection of a representation in the first region corresponding to the content.

11. A method comprising:
presenting a creation interface in response to a user input to an application on a user device, the user input being a request to generate a content comprising two or more content items;
receiving a user input providing a first content item;
receiving a user input providing a second content item;
associating the first content item with the second content item to generate a dual content item, wherein the first content item is a primary content item and the second content item is a secondary content item; and
providing the dual content item to a social media platform, wherein the dual content item is available for presentation to one or more user devices.

12. The method of claim 11, wherein receiving the user input providing the first content item comprises activating a camera feature of the user device and receiving a user capture of the first content item using the camera.

13. The method of claim 11, wherein receiving the user input providing the first content item further comprises receiving a user specification of one or more annotations to the first content item.

14. The method of claim 11, further comprising:
providing a preview of the created content including the first content item and the second content item, wherein each content item is represented by a thumbnail version presented in the interface, and wherein the thumbnail version of the content item of the first content item and the second content item not currently being previewed is presented in a reduced size and with a degraded representation of the content item.

15. A system comprising:
one or more computers and one or more storage devices storing instructions that are operable, when executed by the one or more computers, to cause the one or more computers to perform operations comprising:
receiving user selected content at a user device, the content including a first content item and a second content item;
presenting the first content item in region of a user interface of an application;
detecting a first user interaction occurring within a specified area of the region;
determining whether the first user interaction satisfies a threshold duration;
in response to determining that the first user interaction satisfies the threshold duration, presenting the second content item in the region of the user interface in place of the first content item, the second content item being associated with the first content item.

16. The system of claim 15, further comprising:
determining whether a second user interaction occurs in the region within a specified time; and
in response to determining that the second user interaction has not occurred within the specified time, presenting the first content item in the region in place of the second content item.

17. The system of claim 15, wherein in the specified area of the region comprises a graphical user interface element displayed over the first content item.

18. The system of claim 17, further comprising:
in response to detecting the first user interaction:
initiating a first timer, and
generating an animation associated with the graphical user interface element.

19. The system of claim 18, further comprising;
in response to determining that the first user interaction is discontinued before a value of the timer equals the threshold duration, discontinuing the animation associated with the graphical user interface element and discontinuing the timer.

20. The system of claim 15, wherein presenting the second content item comprises starting a second timer.
